(19) United States
(12) Patent Application Publication
(10) Pub. No.: US 2019/0023120 A1
(43) Pub. Date: Jan. 24, 2019

(54) VANE PIVOTS STANDARDIZATION TO A VEHICLE FRAME

(71) Applicant: Valeo North America, Inc., Troy, MI (US)

(72) Inventors: Issmail Meskin, Le Mesnil-Saint-Denis (FR); Stephen Andre, Le Mesnil Saint Denis Cedex (FR)

(73) Assignee: Valeo North America, Inc., Troy, MI (US)

(21) Appl. No.: 15/655,137

(22) Filed: Jul. 20, 2017

(51) Int. Cl. B60K 11/08; F01P 7/10

(52) U.S. Cl. CPC B60K 11/085; F01P 7/10

(57) ABSTRACT

A front-end module for a motor vehicle, including a frame, a vane configured to be assembled to the frame, and a shaft bracket comprising two parts on either side of the frame, wherein the two parts of the shaft bracket are removably fixed to the frame, wherein the shaft bracket is separate from and integrated with the frame, and wherein the vane is positioned against the frame without deformation, and subsequently, the shaft bracket engages with the frame and encloses the vane into position.

### BACKGROUND

Front end modules are complex assembly units disposed on vehicles—these modules are often required to be highly functional, compact, and aesthetically pleasing. Depending on the specific vehicle model, visible portions may include the headlights, the bumpers, and the front grill. Located behind these visible portions may be a cooling module, vanes which are integrated with the frame, washer tank, motor fan, condenser, electrical wiring, engine cooling and crash management system, etc.

In this context, an active grill shutter (AGS) is a product that brings less CO₂ emissions while not impacting the mass of the vehicles. Located in the front end of the vehicle as part of the front end module, the AGS is an assembly of parts that is configured to control and adjust air flow to improve the vehicle's aerodynamics and thermal performance using a system of controlled shutters. Typically, the AGS includes a frame, one or more vanes configured to open and close to let in or out airflow, an actuator, and one or more links between the vanes and the actuator. The AGS may he optimized for air circulation and water-tightness, and may also be used to improve electrical vehicle battery cooling efficiency.

### SUMMARY

In general, in one aspect, the invention relates to a front-end module for a motor vehicle, comprising a frame, a vane configured to be assembled to the frame, and a shaft bracket comprising two parts on either side of the frame, wherein the two parts of the shaft bracket are removably fixed to the frame, wherein the shaft bracket is separate from and integrated with the frame, and wherein the vane is positioned against the frame without deformation, and subsequently, the shaft bracket engages with the frame and encloses the vane into position.

In general, in one aspect, the invention relates to a method for assembly of an active grille shutter (AGS) system for a front-end module of a motor vehicle, comprising positioning a vane against a frame of the AGS without deformation of vane, enclosing the vane with a shaft bracket comprising two parts, the two parts configured to enclose the vane on each of a first side and a second side of the vane, respectively, and removably affixing the shaft bracket to the frame to integrate the shaft bracket with the frame.

Other aspects and advantages of the invention will be apparent from the following description and the appended claims.

### BRIEF DESCRIPTION OF DRAWINGS

FIG. 1A shows a front end module assembly according to one or more embodiments of the invention.

FIG. 1B shows a front end module assembly with integrated vanes according to one or more embodiments of the invention.

FIG. 2 shows a schematic for assembling a vane into the active grill shutter of a vehicle according to one or more embodiments of the invention.

FIG. 3 shows a flow chart for vane assembly according to one or more embodiments of the invention.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description, numerous specific details are set forth in order to provide a more thorough understanding of one or more embodiments of the invention. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a vane” includes reference to one or more of such vanes.

Terms like “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

FIGS, 1A and 1B show a front end module assembly (102) according to one or more embodiments of the invention. The front end module may be of varying sizes, shapes, and forms depending on the vehicles to be fitted. The front end module (102) is fitted behind the grill in the front of a motor vehicle and configured to interface with the vehicle body and provide added protection in the case of a front-end collision and support for vehicle components.

The front end module (102), as shown in FIGS, 1A and 1B, has multiple components including a front end carrier that includes a frame and a bolster integrated with each other (104), and one or more vanes (106). Each of these components is described below. Although not explicitly shown, one of ordinary skill in the art would appreciate that other components such as headlight mounts, engine housing, motor fan, condenser, radiator, washer tank, electrical wiring structures, etc., may also be part of the front end module.

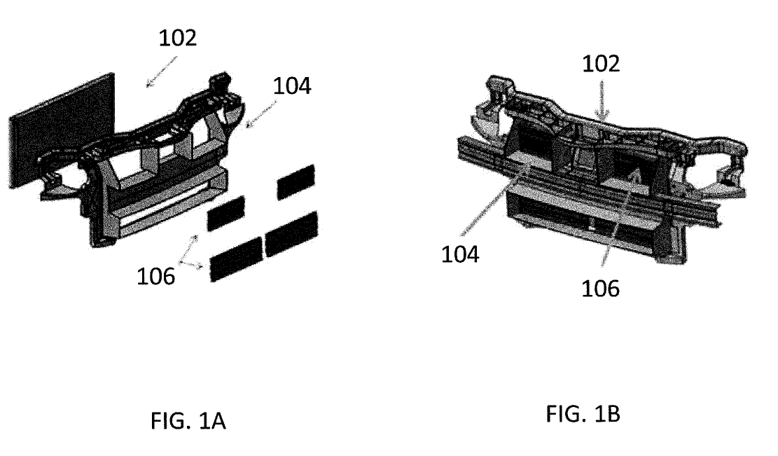

In one or more embodiments, the front end module assembly may include an active grille shutter (AGS) system, which may be all or a portion/subset of the front end assembly (102) including the frame, a shaft bracket, the vanes, links between the vanes and an actuator for actuating the vanes. Accordingly, the elements shown in. FIGS. 1A and 1B may be part of an AGS system, and the terms front-end assembly and AGS may be used interchangeably.

In one or more embodiments, the front end module comprises a bolster (shown integrated with a frame 104 in FIG. 1A and 1B). The bolster may be made of first and second side members, a lower cross member having an extension, and an upper cross member (not shown). Those skilled in the art would appreciate that the combination of the first side member, the second side member, and the lower cross member may be collectively referred to as a bolster.

In one or more embodiments, the bolster may be made of any sturdy material including metals and alloys (e.g., steel, aluminum, etc., and may be of any shape so long as each side member has an impact portion and another portion. Specifically, the impact portion is designed to absorb the most force during an impact, whereas the other portion is designed to maintain the structural integrity of the front end module. In a non-limiting example, the shape of the first and second side members of the bolster may be J-shaped. In this example, the hook portion of the J-shaped side member would be considered the impact portion. Whereas the straight portion of the J-shaped side members would be considered the other portion. The first and second side members may or may not be hollow. These side members are not hollow, but may comprise through holes to enable connection with other components of the vehicle.

The first and second side members may or may not be substantially parallel to one another and may be connected to one another via a substantially horizontal lower cross member that intersects the first and second side members in a substantially perpendicular manner. As with the two side members, the lower cross member may be made of any materials (e.g., aluminum, steel, etc.) capable of providing a sturdy front end carrier that withstands impact or minimizes damages to other components of the front end module. For example, the lower cross member may be made of any metals or alloys. The lower cross member may connect to the first and second side members using any means, including a female-male joint, screws, welding, etc.

As can be seen in FIG. 1B, the frame is the metal part surrounding the vane (106) when the vane is positioned into the front end module assembly (102).

Continuing with FIGS. 1A and 1B, the vanes (106) are shutters which open and close to allow control of the air flow in the front end module of a vehicle. The vanes (106) may be placed behind the grille of the vehicle, into the frame of the front end assembly. In one or more embodiments, an engine control device (e.g., an electronic control module (ECM), not shown) may be configured to request opening or closing of the vanes (106) depending on whether radiator fluid or a coolant is being circulated. In addition, the engine control device may request opening or closing of the vanes (106) based on the speed of the vehicle. For example, during high traveling speed, a high amount of air on the cooling module may not be required, and thus, the vanes (106) may be closed.

Those skilled in the art will appreciate that while FIGS. 1A and 1B show a particular configuration for the front end module, the invention is not limited thereto. Specifically, one of ordinary skill in the art would appreciate that, depending on the specific vehicles to be fitted, the component placements may be rearranged, the various components may contact one another either directly or indirectly, and the materials used for each components may differ.

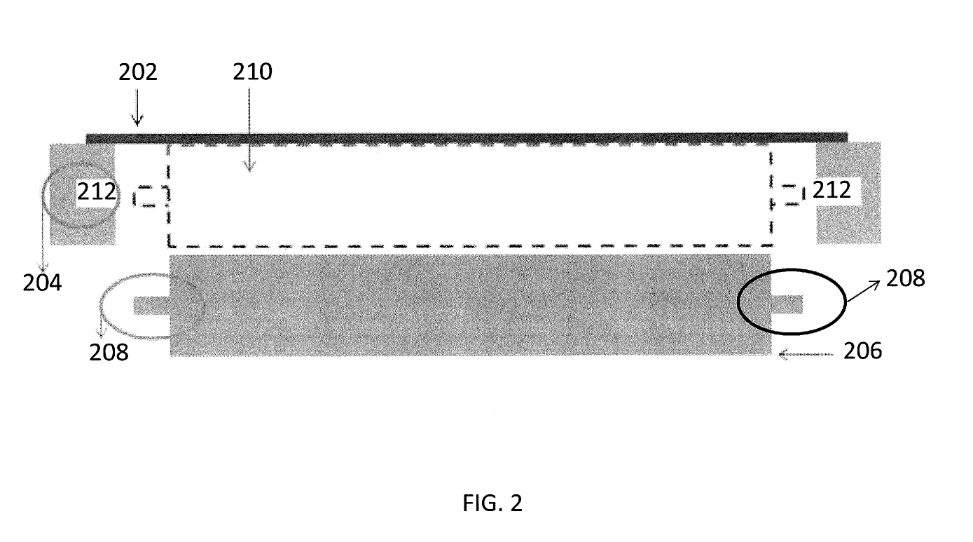

FIG. 2 shows assembly of a vane into the frame in accordance with one or more embodiments of the invention. Specifically, in FIG. 2, the frame (202), a vane (206) and a shaft bracket (204) is shown. Each of the aforementioned components of the assembly are described in detail below.

As shown in FIG. 2, in one or more embodiments, the vane (206) is positioned against the frame (202) in a straight manner, without any deformation of the vane (206). The outline shown by the dotted line (210) in FIG. 2 shows the position of the vane after assembly. In one or more embodiments, the shaft bracket may be a “snap” shaft bracket that is snapped into place, and therefore integrated with the frame, after the insertion of the vane (206) without any bending or twisting of the vane (206). In other words, while the shaft bracket (204) is separate and distinct from the frame (202), and is removably attached to the frame. When the shaft bracket engages with the frame to enclose the vane against the frame, the shaft bracket becomes integrated with the frame. Specifically, in one or more embodiments, the snap bracket may engage with the frame (202) by sliding along the edge of the frame (202) and snapping into place such that the vane pivots (208) fit into the open portion (212) of the shaft bracket (204).

To facilitate this “snapping”, any suitable mechanism may be used. For example, there may be grooves present in the frame into which the shaft bracket slides. Specifically, the shaft bracket may slide horizontally along the frame (202), such that the outer edge of the shaft bracket (204) aligns with the end of the frame (202) and encloses the pivots (208) of the vane(s) (206). Those skilled in the art will appreciate that the invention is not limited to a shaft bracket that snaps into place. Rather, any suitable engagement mechanism may be used to integrate the shaft bracket (204) with the frame (202). For example, pins, rivets, screws, clips, or any other suitable connection mechanism may be used to integrate the shaft bracket (204) with the frame (202) so that the vane(s) (206) is enclosed by the shaft bracket. Specifically, for example, a screw may be used between the shaft bracket and the frame, which affixes the shaft bracket to the frame and encloses the vane(s). In one or more embodiments of the invention, the shaft brackets may be standardized in order to be used in the same manufacturing plant and for different AGS designs.

As described above, the purpose of the pivots (208) is to engage with or fit into the open portion (212) of the shaft bracket. In one or more embodiments, the pivots (208) may be any structure that protrudes off the sides of the vane (206). For example, the pivots (208) may be a prong, a tab, or any other suitable protruding member that is able to engage with the snap shaft bracket to position the vane against the frame (202). The pivots may be made of the same material as the vane, or may be a different material. For example, pivots may be metal, plastic, or any other suitable material.

Those skilled in the art will appreciate that the invention is not limited to the pivots (208) being present on the vane(s) (206). In alternative embodiments, the pivots may be affixed to the shaft bracket (204) rather than to the vane (206). For example, the pivots may protrude from the opening (212) in the shaft bracket. In this case, the vane(s) (206) may include a groove or orifice configured to receive the pivots affixed to the snap bracket.

Those skilled in the art will appreciate that although FIG. 2 shows a single piece vane (206), the illustration may actually represent one or more vanes that may be connected to each other and assembled to the frame together. That is, one or more vanes may be installed/assembled to the frame using one set of shaft brackets as described above.

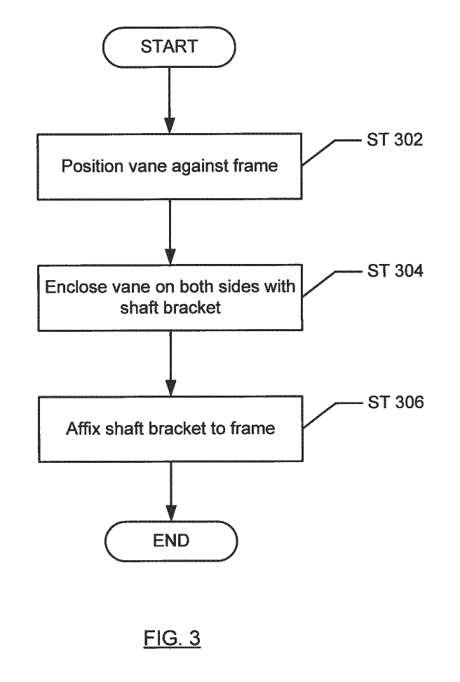

FIG. 3 shows a flow Chart for assembling a vane to the frame of an AGS system in accordance with one or more embodiments. In one or more embodiments, the steps of FIG. 3 are performed sequentially, in the order described below. Initially, the vane is positioned against the frame (ST 302). Specifically in one or more embodiments, the vane may be placed adjacent to and directly in contact with an edge of the frame. In one or more embodiments, the vane may be held in position against the frame by any fixture. For example, an adhesive may be used to hold the vane in place before the shaft bracket encloses the vane against the frame. In other embodiments, fixtures such as rivets, a stretched band (e.g., a tie-bolt), or any other suitable fixture may also be used without departing from the scope of the invention. Those skilled in the art will appreciate that the fixture applied in ST 302 may be a permanent fixture or a temporary fixture that is removable after the shaft snaps the vane into place.

In ST 304, the vane is enclosed on both sides with the shaft bracket. Specifically, the removably attachable shaft brackets are moved into a position that integrates the shaft bracket with the frame. Simultaneously, in ST 304, the vane pivots (or shaft pivots, as the case may be) engage with or are inserted into the orifice of the shaft brackets.

In ST 306, the shaft bracket is affixed to the frame. As described above, the shaft bracket may engage with the frame by any suitable removable mechanism, such as a snap-fitting mechanism. Alternatively, clips, rivets, screws, etc. may be used to affix the shaft brackets on both sides to the frame and enclosed the vane.

Advantageously, embodiments of the invention result in easier installation of the vane with pivots into the vehicle frame of the front-end of the vehicle. Specifically, no bending is required in the vane to allow for the fitting of the vane pivots into the frame, thereby reducing the amount of force required to assembly the vane to the frame. More specifically, the shaft of the frame is snapped into place after insertion of the vane without any bending or twisting of the vane. This allows for ease of automation for the assembly of the vanes into the frame, because the amount of force required to assemble the vane into the frame is reduced as a result of not having to deform the vane in any way to fit the vane into position. Only a straight positioning of the vane against the frame is required.

While the invention has been described with respect to a limited number of embodiments, those skilled in the art, having benefit of this disclosure, will appreciate that other embodiments can be devised which do not depart from the scope of the invention as disclosed herein.

1. A front-end module for a motor vehicle, comprising:
a frame and a bolster integrated with each other;
one or more vanes configured to be assembled to the frame; and
a shaft bracket comprising two parts on either side of the frame, wherein the two parts of the shaft bracket are removably fixed to the frame, wherein the shaft bracket is separate from and integrated with the frame,
wherein the one or more vanes is positioned against the frame without deformation, and subsequently, the shaft bracket engages with the frame and encloses the one or more vanes into position.

2. The front-end module as claimed in claim 1, wherein the shaft bracket is a snap shaft bracket in which the two parts of the shaft bracket are snap-fitted to the frame.

3. The front-end module as claimed in claim 1, further comprising:
at least one pivot that protrudes from the one or more vanes, wherein the at least one pivot is configured to engage with and fit into a corresponding hole in one of the two parts of the shaft bracket.

4. The front-end module as claimed in claim 3, wherein the at least one pivot is affixed to the one or more vanes.

5. The front-end module as claimed in claim 1, further comprising:
at least one pivot that protrudes from at least one of the two parts of the shaft bracket, wherein the at least one pivot is configured to engage with and fit into a corresponding hole in the one or more vanes.

6. The front-end module as claimed in claim 1, wherein the frame, the one or more vanes and the shaft bracket are all part of an active grille shutter system of the front-end module for the motor vehicle.

7. The front-end module as claimed in claim 1, further comprising:
a first pivot that protrudes from a first end of the one or more vanes; and
a second pivot that protrudes from a second end of the one or more vanes opposite to the first end,
wherein the first and second pivots are configured to engage with and fit into corresponding holes in the snap shaft bracket.

8. The front-end module as claimed in claim 1, further comprising:
a first pivot that protrudes from a first end of the shaft bracket; and
a second pivot that protrudes from a second end of the shaft bracket opposite to the first end,
wherein the first and second pivots are configured to engage with and fit into corresponding holes in the one or more vanes.

9. A method for assembly of an active grille shutter (AGS) system for a front-end module of a motor vehicle, comprising:
positioning one or more vanes against a frame of the AGS without deformation of the one or more vanes, wherein a bolster is integrated with the frame;
enclosing the one or more vanes with a shaft bracket comprising two parts, the two parts configured to enclose the one or more vanes on each of a first side and a second side of the one or more vanes, respectively; and
removably affixing the shaft bracket to the frame to integrate the shaft bracket with the frame.

10. The method of claim 9, wherein in the positioning step, the one or more vanes is held against the frame of the AGS using a fixture.

11. The method of claim 9, wherein the shaft bracket is a snap shaft bracket, and wherein removably affixing the shaft bracket to the frame comprises snap-fitting the two parts of the shaft bracket to the frame.

12. The method of claim 9, wherein enclosing the one or more vanes with a shaft bracket comprises fitting at least one pivot that protrudes from the one or more vanes into a corresponding orifice in one of the two parts of the shaft bracket.

13. The method of claim 9, wherein the vane comprises a first pivot on a first end and a second pivot on a second end of the one or more vanes, wherein the first and second pivots are configured to fit into an orifice in the shaft bracket when the shaft bracket encloses the one or more vanes.

14. The method of claim 9, wherein the two parts of the shaft bracket each comprise a pivot, the pivots of the two parts being configured to fit into a hold in the one or more vanes when the shaft bracket encloses the one or more vanes.

15. The method of claim 9, further comprising sliding the shaft bracket into grooves of the frame.

16. The method of claim 13, wherein an outer edge of the shaft bracket aligns with an end of the frame.

17. The method of claim 9, further comprising holding the one or more vanes in place, enclosing the one or more vanes with the shaft bracket, with an adhesive, rivets, or a stretched band.

18. The front-end module as claimed in claim 1, wherein there are four vanes separated from each other in the frame.

19. The front-end module as claimed in claim 18, further comprising a void in the frame to separate the four vanes.

20. The front-end module as claimed in claim 1, further comprising an engine control device configured to open or close the one or more vanes based on if a radiator fluid or a coolant is being circulated.
